(19) United States
(12) Patent Application Publication
(10) Pub. No.: US 2026/0349618 A1
(43) Pub. Date: Nov. 5, 2026

(54) MEMORY DEVICE INCLUDING WORDLINE ISOLATION CIRCUIT AND BURN-IN TEST METHOD THEREOF

(71) Applicant: SAMSUNG ELECTRONICS CO., LTD., Suwon-si (KR)

(72) Inventors: JUYEON SHIN, Suwon-si (KR); Chae-Hyuk Yun, Suwon-si (KR)

(73) Assignee: SAMSUNG ELECTRONICS CO., LTD., Suwon-si (KR)

(21) Appl. No.: 19/533,777

(22) Filed: Feb. 9, 2026

(30) Foreign Application Priority Data
May 2, 2025 (KR) 10-2025-0058321

(51) Int. Cl. G06F 3/06

(52) U.S. Cl. CPC G06F 3/0653; G06F 3/0604; G06F 3/0679

(57) ABSTRACT

A burn-in test method for a memory device is provided. The method includes setting a wordline isolation circuit to a standby mode; setting the wordline isolation circuit to a turn-off state and performing a first burn-in test by outputting a first test voltage from a sub-wordline driver circuit; and changing the wordline isolation circuit to a turn-on state and performing a second burn-in test by outputting a second test voltage lower than the first test voltage from the sub-wordline driver circuit.

### CROSS-REFERENCE TO RELATED APPLICATION

This application is based on and claims priority under 35 U.S.C. § 119 to Korean Patent Application No. 10-2025-0058321 filed on May. 2, 2025, in the Korean Intellectual Property Office, the disclosures of which are incorporated by reference herein in their entireties.

### BACKGROUND

### 1. Field

Example embodiments of the present disclosure described herein relate to a semiconductor memory device, and more particularly, relate to a memory device including a wordline isolation circuit and a burn-in test method thereof.

### 2. Description of Related Art

A semiconductor memory may be mainly classified as a volatile memory or a non-volatile memory. Read and write speeds of the volatile memory (e.g., a dynamic random access memory (DRAM) or a static random access memory (SRAM)) are fast, but data stored in the volatile memory disappear when a power is turned off. In contrast, the non-volatile memory may retain data even when the power is turned off.

Before being shipped as products, the semiconductor memory may undergo various tests including a burn-in test to improve yield and quality. During the burn-in test, the semiconductor memory may apply a same driving voltage to a core/peripheral circuit and a memory cell region. Additionally, to save test time, a test voltage used in the burn-in test may be higher than a normal operating voltage of the semiconductor memory. Accordingly, memory cells that operate normally when the normal operating voltage is applied may be treated as defective memory cells during the burn-in test.

### SUMMARY

Example embodiments of the present disclosure provide a memory device including a wordline isolation circuit capable of isolating a memory cell array from a core/peripheral circuit during a burn-in test.

According to an aspect of an example embodiment, provided is a burn-in test method for a memory device including a memory cell array, a wordline isolation circuit, and a sub-wordline driver circuit, the burn-in test method including includes: performing a first burn-in test by controlling the wordline isolation circuit to a turn-off state and outputting a first test voltage from the sub-wordline driver circuit; and performing a second burn-in test by changing the wordline isolation circuit to a turn-on state and outputting a second test voltage lower than the first test voltage from the sub-wordline driver circuit.

According to an aspect of an example embodiment, provided is a memory device including: a memory cell array including a plurality of memory cells; a plurality of wordlines connected to the plurality of memory cells; a row decoder configured to transmit a wordline driving signal to a selected wordline among the plurality of wordlines; a sub-wordline driver circuit configured to transmit the wordline driving signal to the selected wordline; and a wordline isolation circuit configured to selectively connect or disconnect the plurality of wordlines to or from the sub-wordline driver circuit based on an isolation signal in a burn-in test.

According to an aspect of an example embodiment, provided is a burn-in test method for a memory device including a memory cell array, a plurality of wordlines connected to a plurality of memory cells included in the memory cell array, a sub-wordline driver circuit configured to transmit wordline driving signals to the plurality of wordlines, and a wordline isolation circuit configured to selectively connect or disconnect the plurality of wordlines and the sub-wordline driver circuit based on an isolation signal, the burn-in test method including: disconnecting the plurality of wordlines from the sub-wordline driver circuit by the wordline isolation circuit, and outputting a first test voltage by the sub-wordline driver circuit, based on the memory device being in a process of manufacturing a wafer; disconnecting the plurality of wordlines from the sub-wordline driver circuit by the wordline isolation circuit, and outputting a second test voltage lower than the first test voltage by the sub-wordline driver circuit, based on the memory device being in a process of manufacturing a package; and connecting the plurality of wordlines to the sub-wordline driver circuit by the wordline isolation circuit, and outputting a third test voltage lower than the second test voltage by the sub-wordline driver circuit, based on the memory device being in a module manufacturing process.

### BRIEF DESCRIPTION OF DRAWINGS

The above and other objects and features of the present disclosure will become apparent by describing in detail embodiments thereof with reference to the accompanying drawings.

FIG. 1 is a block diagram illustrating a storage device according to one or more example embodiments.

FIG. 2 is a diagram illustrating a memory device of FIG. 1 according to one or more example embodiments.

FIG. 3 is a diagram illustrating an example embodiment of an arrangement relationship between a sub-wordline driver circuit and a wordline isolation circuit of FIG. 2.

FIG. 4 is a diagram illustrating a connection relationship of a portion A in FIG. 3 according to one or more example embodiments.

FIG. 5 is a diagram illustrating a connection relationship of a portion B in FIG. 3 according to one or more example embodiments.

FIG. 6 is a diagram illustrating an operation method of a wordline isolation circuit during a first operation mode of a memory device of FIG. 3.

FIG. 7 is a diagram illustrating an operation method of a wordline isolation circuit during a second operation mode of a memory device of FIG. 3.

FIG. 8 is a diagram illustrating an operation method of a wordline isolation circuit during a standby mode of a memory device of FIG. 3.

FIG. 9 is a diagram illustrating an operation method of a wordline isolation circuit during a first test mode of a memory device of FIG. 3.

FIG. 10 is a diagram illustrating an operation method of a wordline isolation circuit during a second test mode of a memory device of FIG. 3.

FIG. 11 is a flowchart illustrating an example embodiment of a burn-in test method of a memory device of FIG. 1.

FIG. 12 is a flowchart illustrating another example embodiment of a burn-in test method of a memory device of FIG. 1.

FIG. 13 is a diagram illustrating a connection relationship of a portion A in FIG. 3 according to one or more example embodiments.

FIG. 14 is a diagram illustrating a connection relationship of a portion B in FIG. 3 according to one or more example embodiments.

FIG. 15 is a block diagram illustrating an example embodiment of a memory device of FIG. 1.

FIG. 16 is a block diagram illustrating another example embodiment of a memory device of FIG. 1.

### DETAILED DESCRIPTION

Below, example embodiments of the present disclosure will be described in detail and clearly to such an extent that one ordinarily skilled in the art easily implements the present disclosure.

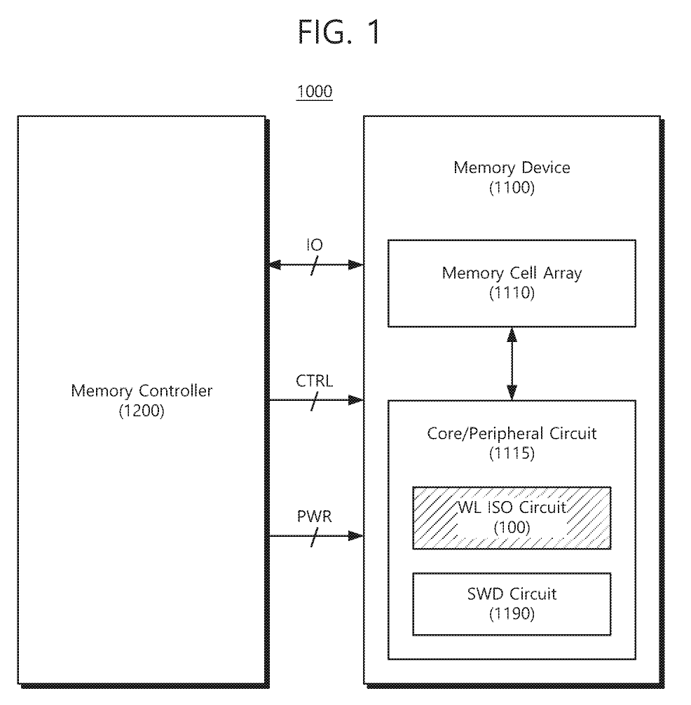

FIG. 1 is a block diagram illustrating a storage device according to an example embodiment of the present disclosure. Referring to FIG. 1, a storage device 1000 may include a memory device 1100 and a memory controller 1200.

The memory device 1100 may receive input/output signals IO from the memory controller 1200 through input/output lines, receive control signals CTRL through control lines, and receive external supply power PWR through power lines. The storage device 1000 may store data in the memory device 1100 under control of the memory controller 1200.

The memory device 1100 may include a memory cell array 1110 and a core/peripheral circuit 1115. The memory cell array 1110 may have a planar two-dimensional (2D) structure or a vertical three-dimensional (3D) structure. The memory cell array 1110 may include a plurality of memory cells. The memory cell array 1110 may be positioned beside or over the core/peripheral circuit 1115.

The memory device 1100 may be a volatile memory device such as a dynamic random access memory (DRAM), a synchronous dynamic random access memory (SDRAM), a double data rate (DDR) DRAM, a DDR SDRAM, a low-power double data rate (LPDDR) SDRAM, a graphics double data rate (GDDR) SDRAM, a Rambus dynamic random access memory (RDRAM), and a static random access memory (SRAM), or the like.

Alternatively, the memory device 1200 may be implemented as a nonvolatile memory device such as a resistive RAM (RRAM), a phase change memory (PRAM), a magnetoresistive memory (MRAM), a ferroelectric memory (FRAM), a spin-transfer torque RAM (STT-RAM), or the like. In the present specification, example embodiments of the present disclosure have been described with respect to a DRAM, but example embodiments are not limited thereto.

The core/peripheral circuit 1115 may include analog circuits and/or digital circuits configured to store data in the memory cell array 1110 and/or read data stored in the memory cell array 1110. The core/peripheral circuit 1115 may receive the external supply power PWR through the power lines and generate internal powers of various levels based on the external supply power PWR.

The core/peripheral circuit 1115 may receive data from the memory controller 1200 through the input/output lines. The core/peripheral circuit 1115 may store data in the memory cell array 1110 according to the control signals CTRL. Alternatively or additionally, the core/peripheral circuit 1115 may read data stored in the memory cell array 1110 and provide the read data to the memory controller 1200.

The core/peripheral circuit 1115 may include a sub-wordline driver circuit 1190. For example, the plurality of memory cells included in the memory cell array 1110 may receive control signals from a row decoder included in the core/peripheral circuit 1115 through a plurality of wordlines. However, a resistor-capacitor (RC) delay may increase when a resistance of the wordlines increases and an output stage of the row decoder configured to drive the wordlines needs to increase, and thus, a high power consumption is required to charge and discharge the entire wordlines to and from a high voltage.

Accordingly, optimization of a length of a wordline is needed to reduce a resistance of the wordline, and a plurality of wordlines may be divided into sub-wordlines having an appropriate length to have a hierarchical wordline structure. The sub-wordline driver circuit 1190 may transmit driving signals received from the row decoder to the sub-wordlines in the hierarchical wordline structure.

When the sub-wordline driver circuit 1190 is connected to the sub-wordlines, a same test voltage may be applied to the core/peripheral circuit 1115 and the memory cell array 1110 during a burn-in test. To save test time and ensure reliability of the core/peripheral circuit 1115, a test voltage higher than an operating voltage of the memory device 1100 may be applied during the burn-in test. However, memory cells included in the memory cell array 1110 may require lower reliability than the core/peripheral circuit 1115. Accordingly, during the burn-in test, an excess number of memory cells may be unnecessarily detected as defective among the memory cells included in the memory cell array 1110.

The core/peripheral circuit 1115 may include a wordline isolation circuit 100. The wordline isolation circuit 100 may connect or isolate the sub-wordlines to or from the sub-wordline driver circuit 1190 based on an isolation control signal. For example, during the burn-in test, the wordline isolation circuit 100 may isolate the sub-wordlines from the sub-wordline driver circuit 1190. During a normal operation (e.g., after product shipment), the wordline isolation circuit 100 may connect the sub-wordlines with the sub-wordline driver circuit 1190. Accordingly, during the burn-in test, a number of memory cells which may be unnecessarily treated as defective among the memory cells of the memory device 1100 may be reduced. Additionally, during the burn-in test, various and/or sophisticated test environments may be set for the core/peripheral circuit 1115 and/or the memory cell array 1110.

As an example, the core/peripheral circuit 1115 may include a core circuit and a peripheral circuit. The sub-wordline driver circuit 1190 and the wordline isolation circuit 100 may be included in the core circuit. The remaining portions of the core/peripheral circuit 1115 excluding the core circuit (for example, a row decoder, a column decoder, and/or control logic, etc.) may be referred to as the peripheral circuit.

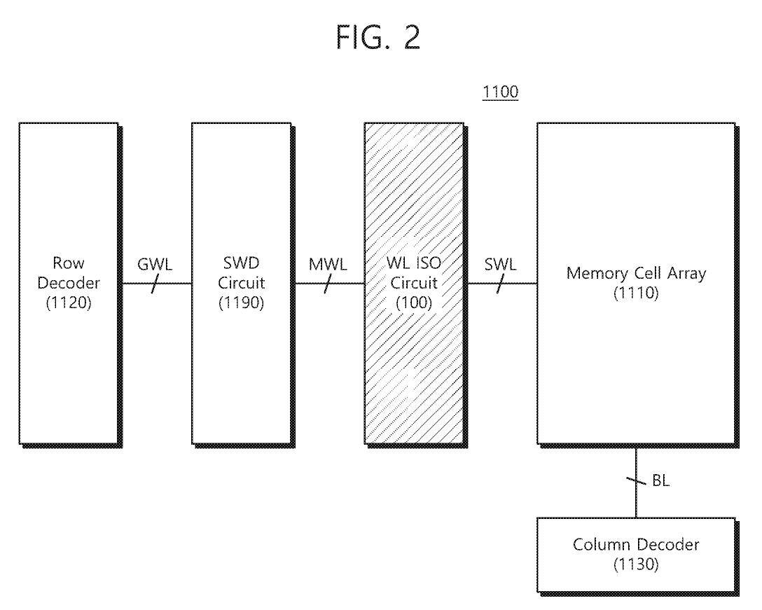

FIG. 2 is a diagram illustrating a memory device of FIG. 1 according to an example embodiment. Referring to FIG. 2, the memory device 1100 may include a memory cell array 1110, a row decoder 1120 and a column decoder 1130. In addition, the memory device 1100 may include a sub-wordline driver circuit 1190 and a wordline isolation circuit 100 disposed between the memory cell array 1110 and the row decoder 1120.

The memory cell array 1110 may include a plurality of memory cells arranged in a matrix form of rows and columns. For example, the memory cell array 1110 may include a plurality of wordlines WL and a plurality of bitlines BL connected to the memory cells. The plurality of wordlines WL may be connected to rows of the memory cells, and the plurality of bitlines BL may be connected to columns of the memory cells.

The row decoder 1120 may select one of the plurality of wordlines WL connected to the memory cell array 1110. The row decoder 1120 may decode a row address included in an address received from the memory controller 1200 of FIG. 1, select one wordline corresponding to the row address, and activate the selected wordline.

The column decoder 1130 may select one of the plurality of bitlines BL of the memory cell array 1110. The column decoder 1130 may decode a column address included in the address received from the memory controller 1200 and select one bitline corresponding to the column address.

The plurality of wordlines WL connected to the memory cell array 1110 may have a hierarchical structure. For example, the plurality of wordlines WL may include global wordlines GWL, intermediate wordlines MWL and sub-wordlines SWL. The global wordlines GWL may be connected between the row decoder 1120 and the sub-wordline driver circuit 1190. The intermediate wordlines MWL may be connected between the sub-wordline driver circuit 1190 and the wordline isolation circuit 100. The sub-wordlines SWL may be connected between the wordline isolation circuit 100 and the memory cell array 1110.

The sub-wordline driver circuit 1190 may include a plurality of sub-wordline drivers. For example, a portion (for example, 8) of the plurality of sub-wordline drivers may be connected to one global wordline GWL. The plurality of sub-wordline drivers may be connected one-to-one with the plurality of intermediate wordlines MWL.

The wordline isolation circuit 100 may include a plurality of wordline isolation switches (or transistors). For example, the plurality of wordline isolation switches may be connected one-to-one with the plurality of intermediate wordlines MWL. Each of the plurality of intermediate wordlines MWL may be connected to the plurality of memory cells included in the memory cell array 1110.

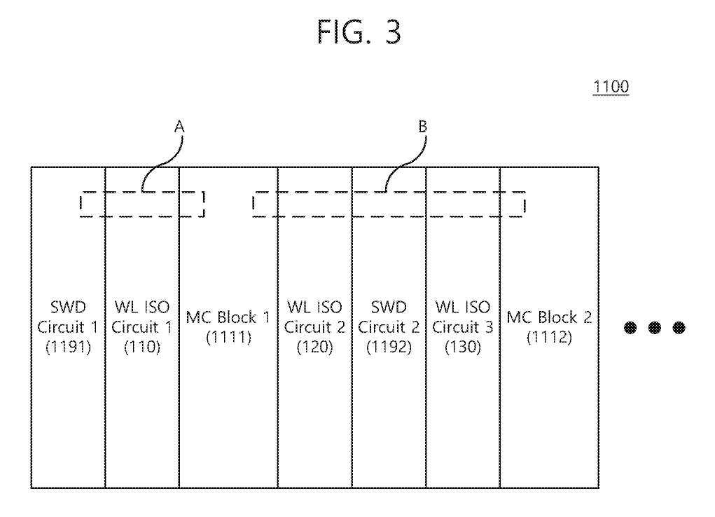

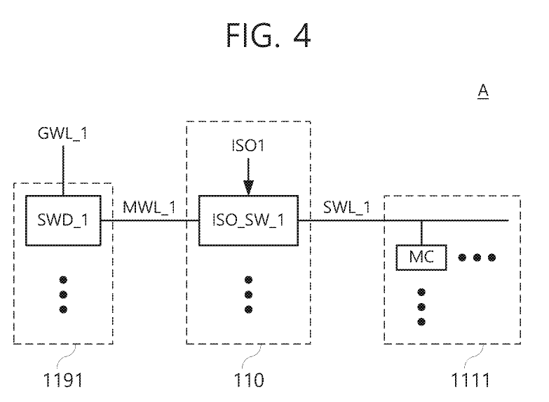

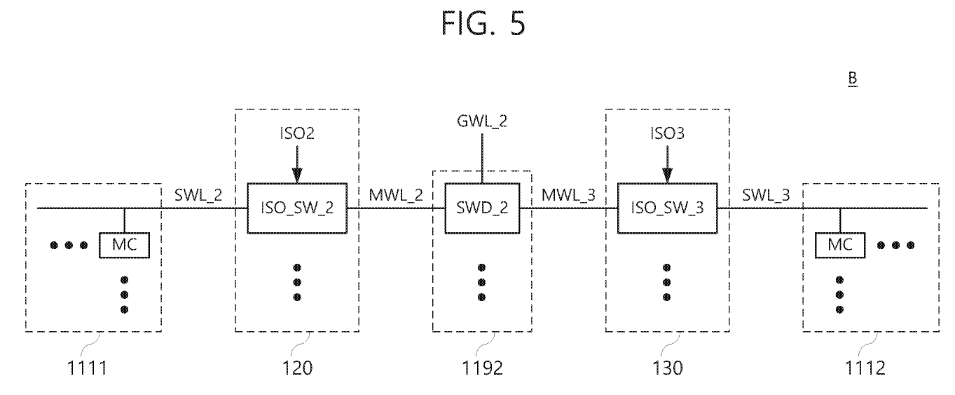

FIG. 3 is a diagram illustrating an example embodiment of an arrangement relationship between a sub-wordline driver circuit and a wordline isolation circuit of FIG. 2. FIG. 4 is a diagram illustrating a connection relationship of a portion A in FIG. 3 according to an example embodiment. FIG. 5 is a diagram illustrating a connection relationship of a portion B in FIG. 3 according to an example embodiment.

Referring to FIGS. 3-5, the memory cell array 1110 of FIG. 2 may include a plurality of memory cell blocks. As an example, the plurality of memory cell blocks may include a first memory cell block 1111 and/or a second memory cell block 1112. The sub-wordline driver circuit 1190 may include a first sub-wordline driver circuit 1191 and/or a second sub-wordline driver circuit 1192. The wordline isolation circuit 100 may include a first wordline isolation circuit 110, a second wordline isolation circuit 120 and/or a third wordline isolation circuit 130.

Referring to FIGS. 3 and 4, the first sub-wordline driver circuit 1191 may be disposed at an edge of the memory cell array 1110. For example, the first sub-wordline driver circuit 1191 may be disposed on one side of the first memory cell block 1111. The first sub-wordline driver circuit 1191 may provide wordline driving signals to a portion of sub-wordlines connected to the first memory cell block 1111.

The first sub-wordline driver circuit 1191 may include a plurality of sub-wordline drivers including a first sub-wordline driver SWD_1. As an example, the first sub-wordline driver SWD_1 may receive a wordline driving signal through a first global wordline GWL_1. The first sub-wordline driver SWD_1 may be connected to a first intermediate wordline MWL_1.

The first wordline isolation circuit 110 may include a plurality of wordline isolation switches including a first wordline isolation switch ISO_SW_1. As an example, the first wordline isolation switch ISO_SW_1 may be connected to the first intermediate wordline MWL_1. Additionally, the first wordline isolation switch ISO_SW_1 may be connected to a first sub-wordline SWL_1. The first sub-wordline SWL_1 may be connected to a portion of memory cells included in the first memory cell block 1111. The first wordline isolation switch ISO_SW_1 may isolate (or separate) the first sub-wordline SWL_1 from the first intermediate wordline MWL_1 and/or the first sub-wordline driver SWD_1 based on a first isolation signal ISO1.

Referring to FIGS. 3 and 5, the second sub-wordline driver circuit 1192 may be disposed between two memory cell blocks. For example, the second sub-wordline driver circuit 1192 may be disposed between the first memory cell block 1111 and the second memory cell block 1112. The second sub-wordline driver circuit 1192 may provide wordline driving signals to a portion of sub-wordlines connected to the first memory cell block 1111. Additionally, the second sub-wordline driver circuit 1192 may provide wordline driving signals to a portion of sub-wordlines connected to the second memory cell block 1112.

The second sub-wordline driver circuit 1192 may include a plurality of sub-wordline drivers including a second sub-wordline driver SWD_2. As an example, the second sub-wordline driver SWD_2 may receive a wordline driving signal through a second global wordline GWL_2. The second sub-wordline driver SWD_2 may be connected to a second intermediate wordline MWL_2. Additionally, the second sub-wordline driver SWD_2 may be connected to a third intermediate wordline MWL_3. That is, the second sub-wordline driver SWD_2 may transmit the wordline driving signal received through the second global wordline GWL_2 to the second intermediate wordline MWL_2 and the third intermediate wordline MWL_3.

The second wordline isolation circuit 120 may include a plurality of wordline isolation switches including a second wordline isolation switch ISO_SW_2. As an example, the second wordline isolation switch ISO_SW_2 may be connected to the second intermediate wordline MWL_2. Additionally, the second wordline isolation switch ISO_SW_2 may be connected to a second sub-wordline SWL_2. The second sub-wordline SWL_2 may be connected to a portion of memory cells included in the first memory cell block 1111. The second wordline isolation switch ISO_SW_2 may isolate (or separate) the second sub-wordline SWL_2 from the second intermediate wordline MWL_2 and/or the second sub-wordline driver SWD_2 based on a second isolation signal ISO2.

The third wordline isolation circuit 130 may include a plurality of wordline isolation switches including a third wordline isolation switch ISO_SW_3. As an example, the third wordline isolation switch ISO_SW_3 may be connected to the third intermediate wordline MWL_3. Additionally, the third wordline isolation switch ISO_SW_3 may be connected to a third sub-wordline SWL_3. The third sub-wordline SWL_3 may be connected to a portion of memory cells included in the second memory cell block 1112. The third wordline isolation switch ISO_SW_3 may isolate (or separate) the third sub-wordline SWL_3 from the third intermediate wordline MWL_3 and/or the second sub-wordline driver SWD_2 based on a third isolation signal ISO3.

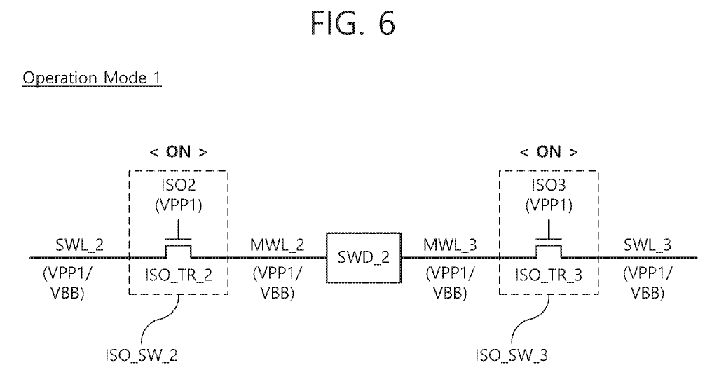

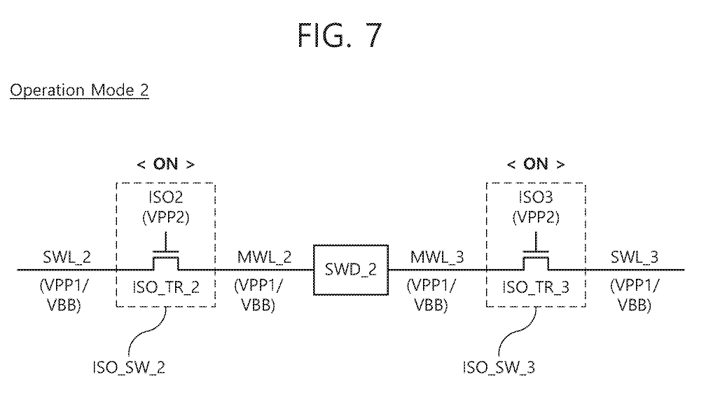

FIG. 6 is a diagram illustrating an operation method of a wordline isolation circuit during a first operation mode of a memory device of FIG. 3. FIG. 7 is a diagram illustrating an operation method of a wordline isolation circuit during a second operation mode of a memory device of FIG. 3. Referring to FIGS. 6 and 7, operations of the second wordline isolation switch ISO_SW_2 and the third wordline isolation switch ISO_SW_3 connected to the second sub-wordline driver SWD_2 are described according to an example embodiment. However, wordline isolation switches included in the memory device 1100 may operate identically to the second wordline isolation switch ISO_SW_2 and/or the third wordline isolation switch ISO_SW_3.

As an example, the second wordline isolation switch ISO_SW_2 may include a second wordline isolation transistor ISO_TR_2. The third wordline isolation switch ISO_SW_3 may include a third wordline isolation transistor ISO_TR_3. The second wordline isolation transistor ISO_TR_2 and/or the third wordline isolation transistor ISO_TR_3 may be implemented as N-type transistors. However, this is an example, and the second wordline isolation transistor ISO_TR_2 and/or the third wordline isolation transistor ISO_TR_3 may be implemented as P-type transistors.

Referring to FIG. 6, in the first operation mode, the second wordline isolation switch ISO_SW_2 and the third wordline isolation switch ISO_SW_3 may be turned on. For example, the second isolation signal ISO2 having a first power voltage VPP1 may be input to a gate of the second wordline isolation transistor ISO_TR_2. The third isolation signal ISO3 having the first power voltage VPP1 may be input to a gate of the third wordline isolation transistor ISO_TR_3. Accordingly, a voltage of the second intermediate wordline MWL_2 (for example, the first power voltage VPP1 or a ground voltage VBB) may be transmitted as-is to the second sub-wordline SWL_2. A voltage of the third intermediate wordline MWL_3 (for example, the first power voltage VPP1 or the ground voltage VBB) may be transmitted as-is to the third sub-wordline SWL_3.

Referring to FIG. 7, in the second operation mode, the second wordline isolation switch ISO_SW_2 and the third wordline isolation switch ISO_SW_3 may be turned on. An output voltage of the second sub-wordline driver SWD_2 (for example, the first power voltage VPP1 or the ground voltage VBB) may be transmitted more reliably in the second operation mode than in the first operation mode. For example, the second isolation signal ISO2 having a second power voltage VPP2 higher than the first power voltage VPP1 may be input to the gate of the second wordline isolation transistor ISO_TR_2. The third isolation signal ISO3 having the second power voltage VPP2 may be input to the gate of the third wordline isolation transistor ISO_TR_3. Accordingly, the voltage of the second intermediate wordline MWL_2 (for example, the first power voltage VPP1 or the ground voltage VBB) may be transmitted as-is to the second sub-wordline SWL_2. The voltage of the third intermediate wordline MWL_3 (for example, the first power voltage VPP1 or the ground voltage VBB) may be transmitted as-is to the third sub-wordline SWL_3.

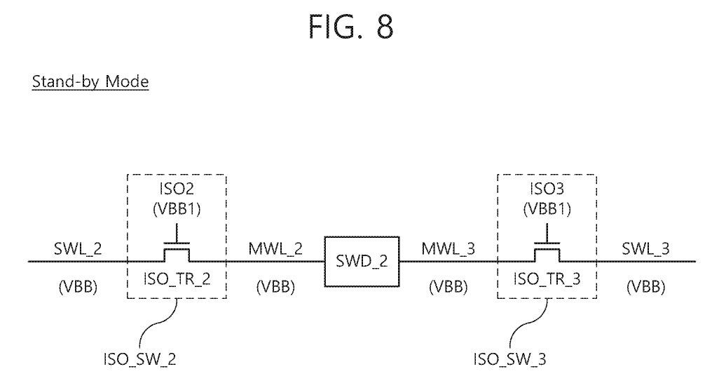

FIG. 8 is a diagram illustrating an operation method of a wordline isolation circuit during a standby mode of a memory device of FIG. 3. Referring to FIG. 8, operations of the second wordline isolation switch ISO_SW_2 and the third wordline isolation switch ISO_SW_3 connected to the second sub-wordline driver SWD_2 are described according to an example embodiment. However, wordline isolation switches included in the memory device 1100 may operate identically to the second wordline isolation switch ISO_SW_2 and/or the third wordline isolation switch ISO_SW_3. During the standby mode before the burn-in test, the second intermediate wordline MWL_2 and the third intermediate wordline MWL_3 may be set to the ground voltage VBB.

During the standby mode, the memory cell array 1110 may be isolated from or connected to the core/peripheral circuit 1115. For example, during the standby mode, the second wordline isolation switch ISO_SW_2 and the third wordline isolation switch ISO_SW_3 may be set variously.

For example, during the standby mode, the second isolation signal ISO2 having a first ground bias voltage VBB1 may be input to the gate of the second wordline isolation transistor ISO_TR_2. The third isolation signal ISO3 having the first ground bias voltage VBB1 may be input to the gate of the third wordline isolation transistor ISO_TR_3.

As an example, the first ground bias voltage VBB1 may be set equal to or lower than the ground voltage VBB. Accordingly, the second wordline isolation transistor ISO_TR_2 and the third wordline isolation transistor ISO_TR_3 may be turned off. The second sub-wordline SWL_2 may be separated from the second intermediate wordline MWL_2. The third sub-wordline SWL_3 may be separated from the third intermediate wordline MWL_3.

As another example, the first ground bias voltage VBB1 may be set higher than the ground voltage VBB. Accordingly, during the standby mode, the second wordline isolation transistor ISO_TR_2 and the third wordline isolation transistor ISO_TR_3 may be weakly turned on. The second sub-wordline SWL_2 may be set to the same or similar voltage as the second intermediate wordline MWL_2. The third sub-wordline SWL_3 may be set to the same or similar voltage as the third intermediate wordline MWL_3.

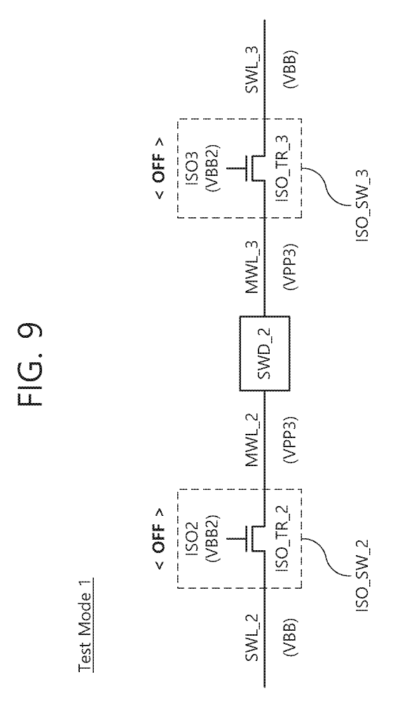

FIG. 9 is a diagram illustrating an operation method of a wordline isolation circuit during a first test mode of a memory device of FIG. 3. Referring to FIG. 9, operations of the second wordline isolation switch ISO_SW_2 and the third wordline isolation switch ISO_SW_3 connected to the second sub-wordline driver SWD_2 are described according to an example embodiment. However, wordline isolation switches included in the memory device 1100 may operate identically to the second wordline isolation switch ISO_SW_2 and/or the third wordline isolation switch ISO_SW_3.

During the first test mode of the burn-in test, the second intermediate wordline MWL_2 and the third intermediate wordline MWL_3 may be set to a third power voltage VPP3 higher than the first power voltage VPP1 of FIG. 6. The third power voltage VPP3 may have a level that is set based on the reliability of the core/peripheral circuit 1115. Through the third power voltage VPP3, the core/peripheral circuit 1115 including the sub-wordline driver circuit 1190 may perform the burn-in test using a test voltage (for example, the third power voltage VPP3) higher than a normal operating voltage (for example, the first power voltage VPP1).

During the first test mode, the memory device 1100 may isolate the memory cell array 1110 from the core/peripheral circuit 1115. During the first test mode, without driving the memory cell array 1110, the memory device 1100 may perform the burn-in test by driving the core/peripheral circuit 1115. For example, the second wordline isolation switch ISO_SW_2 and the third wordline isolation switch ISO_SW_3 may be turned off. The second isolation signal ISO2 having a second ground bias voltage VBB2 may be input to the gate of the second wordline isolation transistor ISO_TR_2. The third isolation signal ISO3 having the second ground bias voltage VBB2 may be input to the gate of the third wordline isolation transistor ISO_TR_3.

The second ground bias voltage VBB2 may be set to a voltage sufficient to turn off the second wordline isolation switch ISO_SW_2 and the third wordline isolation switch ISO_SW_3. As an example, the second ground bias voltage VBB2 may be set equal to or lower than the ground voltage VBB. As another example, to avoid leakage current in a GIDL (gate induced drain leakage) region, the second ground bias voltage VBB2 may be set slightly higher than the ground voltage VBB. Accordingly, the second wordline isolation transistor ISO_TR_2 and the third wordline isolation transistor ISO_TR_3 may be turned off. The second sub-wordline SWL_2 may be separated from the second intermediate wordline MWL_2. The third sub-wordline SWL_3 may be separated from the third intermediate wordline MWL_3.

Therefore, during the burn-in test, a number of memory cells that may be unnecessarily treated as defective among the memory cells of the memory device 1100 may be reduced. Furthermore, during the burn-in test, various and/or sophisticated test environments may be set for the core/peripheral circuit 1115.

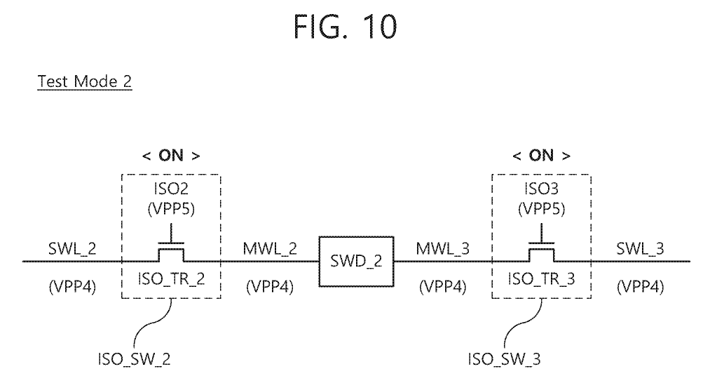

FIG. 10 is a diagram illustrating an operation method of a wordline isolation circuit during a second test mode of a memory device of FIG. 3. Referring to FIG. 10, operations of the second wordline isolation switch ISO_SW_2 and the third wordline isolation switch ISO_SW_3 connected to the second sub-wordline driver SWD_2 are described according to an example embodiment. However, wordline isolation switches included in the memory device 1100 may operate identically to the second wordline isolation switch ISO_SW_2 and/or the third wordline isolation switch ISO_SW_3.

During the second test mode of the burn-in test, the second intermediate wordline MWL_2 and the third intermediate wordline MWL_3 may be set to a fourth power voltage VPP4 higher than the first power voltage VPP1 of FIG. 6. However, the fourth power voltage VPP4 may be set lower than the third power voltage VPP3 of FIG. 9. The fourth power voltage VPP4 may have a level that is set based on the reliability of memory cells included in the memory cell array 1110.

During the second test mode, the memory device 1100 may perform the burn-in test with the memory cell array 1110 connected to the core/peripheral circuit 1115. During the second test mode, the memory device 1100 may perform the burn-in test by driving both the memory cell array 1110 and the core/peripheral circuit 1115. For example, the second wordline isolation switch ISO_SW_2 and the third wordline isolation switch ISO_SW_3 may be turned on.

During the second test mode, the second isolation signal ISO2 having a fifth power voltage VPP5 higher than the first power voltage VPP1 of FIG. 6 may be input to the gate of the second wordline isolation transistor ISO_TR_2. The third isolation signal ISO3 having the fifth power voltage VPP5 may be input to the gate of the third wordline isolation transistor ISO_TR_3.

The fifth power voltage VPP5 may be set to a voltage sufficient to turn on the second wordline isolation transistor ISO_TR_2 and the third wordline isolation transistor ISO_TR_3. As an example, the fifth power voltage VPP5 may be set equal to the fourth power voltage VPP4. As another example, the fifth power voltage VPP5 may be set different from the fourth power voltage VPP4. Accordingly, the second wordline isolation transistor ISO_TR_2 and the third wordline isolation transistor ISO_TR_3 may be turned on. The second sub-wordline SWL_2 may be connected to the second intermediate wordline MWL_2. The third sub-wordline SWL_3 may be connected to the third intermediate wordline MWL_3.

Through the fourth power voltage VPP4, the memory device 1100 may perform the burn-in test on the entire memory device 1100 using a test voltage (for example, the fourth power voltage VPP4) which is higher than the normal operating voltage (for example, the first power voltage VPP1) while preventing unnecessary defects in memory cells. Therefore, during the burn-in test, memory cells which may be unnecessarily treated as defective among the memory cells of the memory device 1100 may be reduced. Furthermore, during the burn-in test, various and/or sophisticated test environments may be set for the core/peripheral circuit 1115 and/or memory cell array 1110.

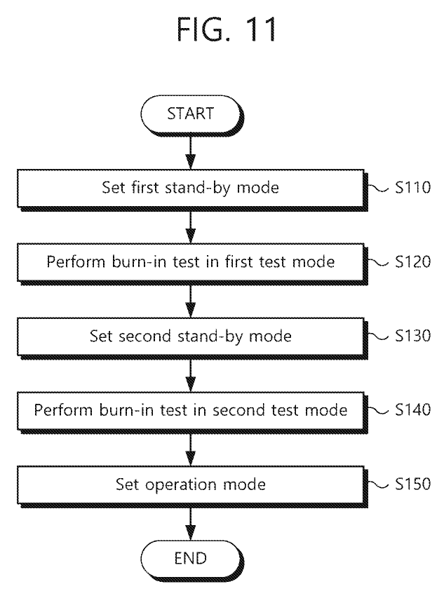

FIG. 11 is a flowchart illustrating an example embodiment of a burn-in test method of a memory device of FIG. 1. Referring to FIGS. 3-11, the memory device 1100 may perform a burn-in test in various test environments based on different reliability criteria of the memory cell array 1110 and/or the core/peripheral circuit 1115.

In operation S110, the memory device 1100 may be set to a first standby mode. For example, referring to FIG. 8, in the first standby mode, the sub-wordline driver circuit 1190 may output the first ground bias voltage VBB1, and the wordline isolation circuit 100 may be turned on or off.

In operation S120, the memory device 1100 may perform the burn-in test in a first test mode. For example, referring to FIG. 9, the wordline isolation circuit 100 may be turned off. Accordingly, the memory cell array 1110 may be isolated from the core/peripheral circuit 1115. In the first test mode, the core/peripheral circuit 1115 may perform the burn-in test with a first test voltage (for example, the third power voltage VPP3).

In operation S130, the memory device 1100 may be set to a second standby mode. For example, referring to FIG. 8, the second standby mode may be set substantially similarly to the first standby mode. As an example, in the second standby mode, the wordline isolation circuit 100 may be turned on.

In operation S140, the memory device 1100 may perform the burn-in test in a second test mode. For example, referring to FIG. 10, the wordline isolation circuit 100 may be turned on. Accordingly, the memory cell array 1110 may be connected to the core/peripheral circuit 1115. In the second test mode, the memory cell array 1110 and the core/peripheral circuit 1115 may perform the burn-in test with a second test voltage (for example, the fourth power voltage VPP4) lower than the first test voltage.

In operation S150, the memory device 1100 may be set to a normal operation mode. For example, referring to FIG. 6 or FIG. 7, the wordline isolation circuit 100 may maintain a turned-on state. A control voltage of the wordline isolation circuit 100 may be changed variously.

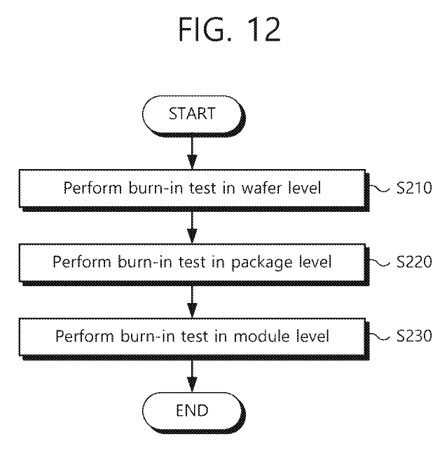

FIG. 12 is a flowchart illustrating another example embodiment of a burn-in test method of a memory device of FIG. 1. Referring to FIGS. 3-10 and 12, the memory device 1100 may perform a burn-in test in various test environments based on different reliability criteria of the memory cell array 1110 and/or the core/peripheral circuit 1115. Additionally, the memory device 1100 may perform the burn-in test in various manufacturing processes.

In operation S210, the memory device 1100 may perform the burn-in test at a wafer level. For example, in a process of manufacturing a wafer, the memory device 1100 may perform the burn-in test through the burn-in test method of FIG. 11. In the first test mode, a first wafer test voltage may be used as the first test voltage. In the second test mode, a second wafer test voltage may be used as the second test voltage.

In operation S220, the memory device 1100 may perform the burn-in test at a package level. For example, in a process of manufacturing a package, the memory device 1100 may perform the burn-in test through the burn-in test method of FIG. 11. In the first test mode, a first package test voltage may be used as the first test voltage. As an example, the first package test voltage may be set lower than the first wafer test voltage. In the second test mode, a second package test voltage may be used as the second test voltage. As an example, the second package test voltage may be set lower than the second wafer test voltage.

In operation S230, the memory device 1100 may perform the burn-in test at a module level. For example, in a process of manufacturing a module, the memory device 1100 may perform the burn-in test through the burn-in test method of FIG. 11. In the first test mode, a first module test voltage may be used as the first test voltage. As an example, the first module test voltage may be set lower than the first package test voltage.

In the second test mode, a second module test voltage may be used as the second test voltage. As an example, the second module test voltage may be set lower than the second package test voltage. As another example, the second module test voltage may be set equal to the normal operating voltage of the memory device 1100. The second test mode of the package level may be set to have a longer test time than the second test mode of the wafer level or the package level.

Although presented as separate steps, the steps of the flowchart in FIGS. 11 or 12 may occur simultaneously or in a different order than illustrated here. In an embodiment, the steps may be rearranged, other steps may be included between the illustrated steps, steps may be omitted or replaced, etc.

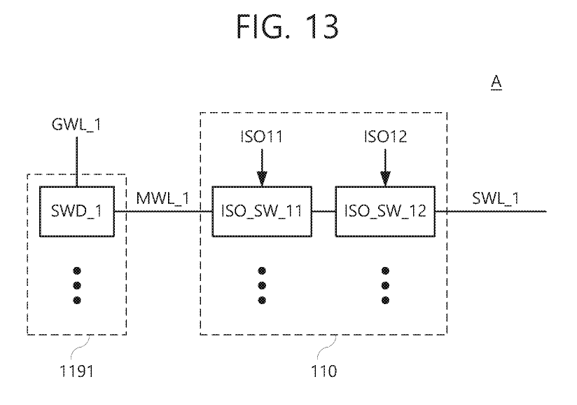

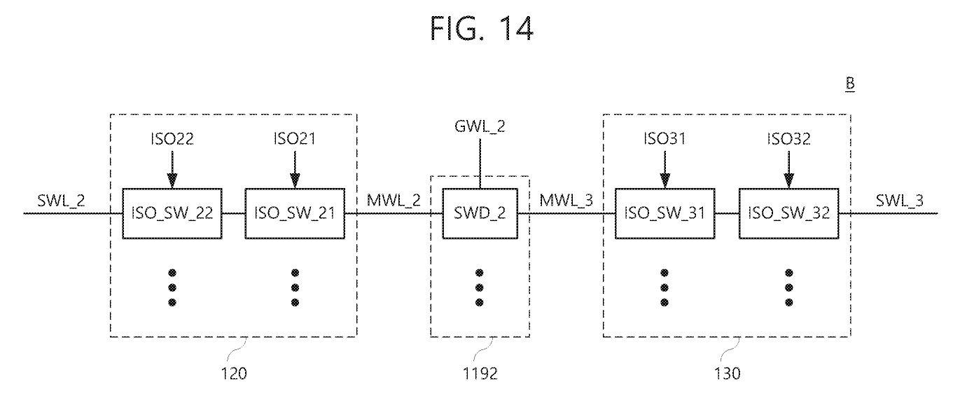

FIG. 13 is a diagram illustrating a connection relationship of a portion A in FIG. 3 according to an example embodiment. FIG. 14 is a diagram illustrating a connection relationship of a portion B in FIG. 3 according to an example embodiment.

Referring to FIGS. 3, 13 and 14, the plurality of memory cell blocks may include a first memory cell block 1111 and/or a second memory cell block 1112. The sub-wordline driver circuit 1190 may include a first sub-wordline driver circuit 1191 and/or a second sub-wordline driver circuit 1192. The wordline isolation circuit 100 may include a first wordline isolation circuit 110, a second wordline isolation circuit 120 and/or a third wordline isolation circuit 130.

Referring to FIGS. 3 and 13, the first sub-wordline driver circuit 1191 may be disposed at an edge of the memory cell array 1110. For example, the first sub-wordline driver circuit 1191 may be disposed on one side of the first memory cell block 1111. The first sub-wordline driver circuit 1191 may provide wordline driving signals to a portion of the sub-wordlines connected to the first memory cell block 1111.

The first sub-wordline driver circuit 1191 may include a plurality of sub-wordline drivers including a first sub-wordline driver SWD_1. As an example, the first sub-wordline driver SWD_1 may receive a wordline driving signal through a first global wordline GWL_1. The first sub-wordline driver SWD_1 may be connected to a first intermediate wordline MWL_1.

The first wordline isolation circuit 110 may connect intermediate wordlines and sub-wordlines through a plurality of wordline isolation switches. As an example, an eleventh wordline isolation switch ISO_SW_11 may be connected to the first intermediate wordline MWL_1. The eleventh wordline isolation switch ISO_SW_11 may be connected in series to a twelfth wordline isolation switch ISO_SW_12. The twelfth wordline isolation switch ISO_SW_12 may be connected to a first sub-wordline SWL_1.

The first sub-wordline SWL_1 may be connected to a portion of the memory cells included in the first memory cell block 1111. The eleventh wordline isolation switch ISO_SW_11 and the twelfth wordline isolation switch ISO_SW_12 may isolate (or separate) the first sub-wordline SWL_1 from the first intermediate wordline MWL_1 and/or the first sub-wordline driver SWD_1. For example, the eleventh wordline isolation switch ISO_SW_11 may be turned on or turned off based on an eleventh isolation signal ISO11. The twelfth wordline isolation switch ISO_SW_12 may be turned on or turned off based on a twelfth isolation signal ISO12. As an example, the eleventh isolation signal ISO11 and the twelfth isolation signal ISO12 may be set to the same voltage level. As another example, the eleventh isolation signal ISO11 and twelfth isolation signal ISO12 may be set to different voltage levels.

Referring to FIGS. 3 and 14, the second sub-wordline driver circuit 1192 may be disposed between two memory cell blocks. For example, the second sub-wordline driver circuit 1192 may be disposed between the first memory cell block 1111 and the second memory cell block 1112. The second sub-wordline driver circuit 1192 may provide wordline driving signals to a portion of the sub-wordlines connected to the first memory cell block 1111. Additionally, the second sub-wordline driver circuit 1192 may provide wordline driving signals to a portion of the sub-wordlines connected to the second memory cell block 1112.

The second sub-wordline driver circuit 1192 may include a plurality of sub-wordline drivers including a second sub-wordline driver SWD_2. As an example, the second sub-wordline driver SWD_2 may receive a wordline driving signal through a second global wordline GWL_2. The second sub-wordline driver SWD_2 may be connected to a second intermediate wordline MWL_2. Additionally, the second sub-wordline driver SWD_2 may be connected to a third intermediate wordline MWL_3. That is, the second sub-wordline driver SWD_2 may transmit the wordline driving signal received through the second global wordline GWL_2 to the second intermediate wordline MWL_2 and the third intermediate wordline MWL_3.

The second wordline isolation circuit 120 may connect intermediate wordlines and sub-wordlines through a plurality of wordline isolation switches. As an example, a twenty-first wordline isolation switch ISO_SW_21 may be connected to the second intermediate wordline MWL_2. The twenty-first wordline isolation switch ISO_SW_21 may be connected in series to a twenty-second wordline isolation switch ISO_SW_22. The twenty-second wordline isolation switch ISO_SW_22 may be connected to a second sub-wordline SWL_2.

The second sub-wordline SWL_2 may be connected to a portion of the memory cells included in the first memory cell block 1111. The twenty-first wordline isolation switch ISO_SW_21 and the twenty-second wordline isolation switch ISO_SW_22 may isolate (or separate) the second sub-wordline SWL_2 from the second intermediate wordline MWL_2 and/or the second sub-wordline driver SWD_2. For example, the twenty-first wordline isolation switch ISO_SW_21 may be turned on or turned off based on a twenty-first isolation signal ISO21. The twenty-second wordline isolation switch ISO_SW_22 may be turned on or turned off based on a twenty-second isolation signal ISO22. As an example, the twenty-first isolation signal ISO21 and the twenty-second isolation signal ISO22 may be set to the same voltage level. As another example, the twenty-first isolation signal ISO21 and the twenty-second isolation signal ISO22 may be set to different voltage levels.

The third wordline isolation circuit 130 may connect intermediate wordlines and sub-wordlines through a plurality of wordline isolation switches. As an example, a thirty-first wordline isolation switch ISO_SW_31 may be connected to the third intermediate wordline MWL_3. The thirty-first wordline isolation switch ISO_SW_31 may be connected in series to a thirty-second wordline isolation switch ISO_SW_32. The thirty-second wordline isolation switch ISO_SW_32 may be connected to a third sub-wordline SWL_3.

The third sub-wordline SWL_3 may be connected to a portion of the memory cells included in the second memory cell block 1112. The thirty-first wordline isolation switch ISO_SW_31 and the thirty-second wordline isolation switch ISO_SW_32 may isolate (or separate) the third sub-wordline SWL_3 from the third intermediate wordline MWL_3 and/or the second sub-wordline driver SWD_2. For example, the thirty-first wordline isolation switch ISO_SW_31 may be turned on or turned off based on a thirty-first isolation signal ISO31. The thirty-second wordline isolation switch ISO_SW_32 may be turned on or turned off based on a thirty-second isolation signal ISO32. As an example, the thirty-first isolation signal ISO31 and the thirty-second isolation signal ISO32 may be set to the same voltage level. As another example, the thirty-first isolation signal ISO31 and the thirty-second isolation signal ISO32 may be set to different voltage levels.

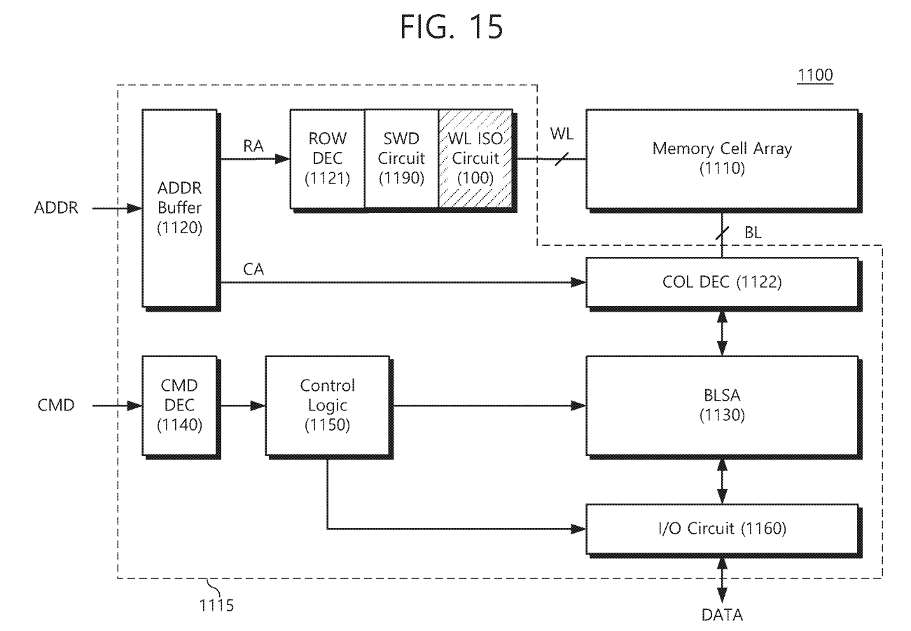

FIG. 15 is a block diagram illustrating an example embodiment of a memory device of FIG. 1. Referring to FIGS. 1 and 15, the memory device 1100 may include a memory cell array 1110 and a core/peripheral circuit 1115. The core/peripheral circuit 1115 may include an address buffer 1120, a row decoder 1121, a column decoder 1122, a bitline sense amplifier 1130, a command decoder 1140, a control logic 1150 and an input/output circuit 1160. Additionally, the core/peripheral circuit 1115 may include a sub-wordline driver circuit 1190 and a wordline isolation circuit 100.

The memory cell array 1110 may include a plurality of memory cells arranged in a matrix form of rows and columns. For example, the memory cell array 1110 may include a plurality of wordlines WL and a plurality of bitlines BL connected to the plurality of memory cells. The plurality of wordlines WL may be connected to rows of the memory cells, and the plurality of bitlines BL may be connected to columns of the memory cells.

The address buffer 1120 may receive an address ADDR from the memory controller 1200 of FIG. 1. For example, the address ADDR may include a row address RA addressing a row of the memory cell array 1110 and a column address CA addressing a column of the memory cell array 1110. The address buffer 1120 may transmit the row address RA to the row decoder 1121 and transmit the column address CA to the column decoder 1122.

The row decoder 1121 may select one of the plurality of wordlines WL connected to the memory cell array 1110. The row decoder 1121 may decode the row address RA received from the address buffer 1120, select one wordline corresponding to the row address RA, and activate the selected wordline.

The column decoder 1122 may select one of the plurality of bitlines BL connected to the memory cell array 1110. The column decoder 1122 may decode the column address CA received from the address buffer 1120 and select one bitline BL corresponding to the column address CA.

The bitline sense amplifier 1130 may be connected to the bitlines BL of the memory cell array 1110. For example, the bitline sense amplifier 1130 may detect voltage changes of selected bitlines among the plurality of bitlines BL, amplify the voltage changes, and output the amplified signals.

The command decoder 1140 may decode a write enable signal (/WE), a row address strobe signal (/RAS), a column address strobe signal (/CAS), a chip selection signal (/CS), etc., received from the memory controller 1200 to cause control signals corresponding to a command CMD to be generated in the control logic 1150. The command CMD may include an active request, a read request, a write request and/or precharge request, etc.

The control logic 1150 may control overall operations of the bitline sense amplifier 1130 and/or an input/output circuit 1160 through control signals corresponding to the command CMD. Additionally, the control logic 1150 may control overall operations of the memory device 1100.

The input/output circuit 1160 may output data DATA to the memory controller 1200 through data pad based on a sensed and amplified voltage from the bitline sense amplifier 1130. For example, the input/output circuit 1160 may include an input buffer or an output buffer. The input/output circuit 1160 may perform a serialization operation or a deserialization operation of the data DATA.

The sub-wordline driver circuit 1190 may receive wordline driving signals from the row decoder 1121. When the sub-wordline driver circuit 1190 is connected to wordlines, the same test voltage may be applied to the core/peripheral circuit 1115 and memory cell array 1110 during the burn-in test. To save test time and ensure reliability of the core/peripheral circuit 1115, a test voltage higher than the operating voltage of the memory device 1100 may be applied during the burn-in test. However, memory cells included in the memory cell array 1110 may require lower reliability than the core/peripheral circuit 1115. Accordingly, during the burn-in test, an excessive number of memory cells may be unnecessarily detected as defective among the memory cells included in the memory cell array 1110.

The core/peripheral circuit 1115 may include the wordline isolation circuit 100. As described in FIGS. 3-14, the wordline isolation circuit 100 may connect or isolate wordlines to or from the sub-wordline driver circuit 1190. For example, during the burn-in test, the wordline isolation circuit 100 may isolate wordlines from the sub-wordline driver circuit 1190. During a normal operation (e.g., after a product shipment), the wordline isolation circuit 100 may connect wordlines to the sub-wordline driver circuit 1190. Accordingly, during the burn-in test, memory cells which may be unnecessarily treated as defective among the memory cells of the memory device 1100 may be reduced. Additionally, during the burn-in test, various and/or sophisticated test environments may be set for the core/peripheral circuit 1115 and/or the memory cell array 1110.

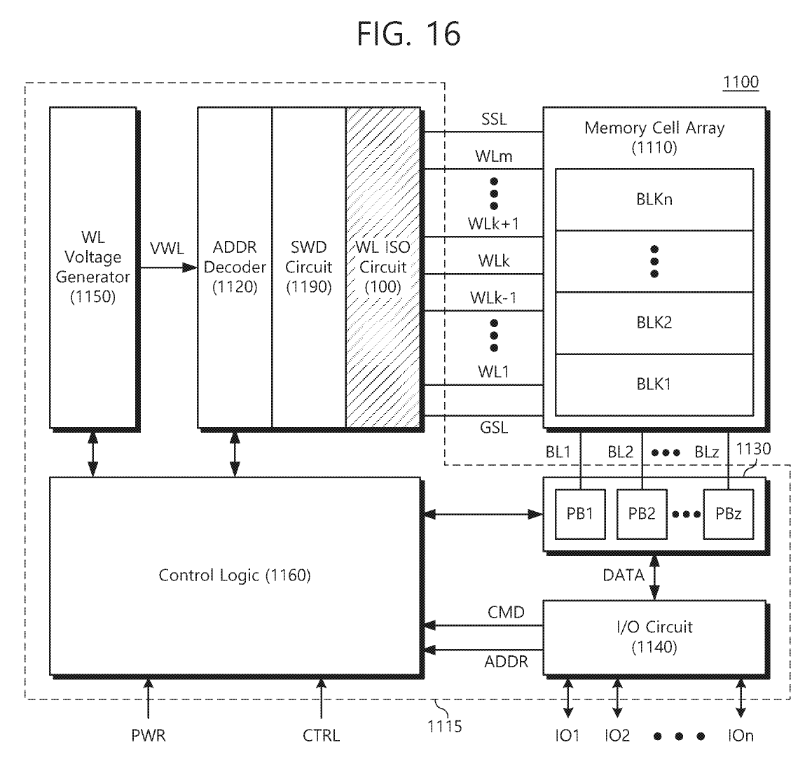

FIG. 16 is a block diagram illustrating another example embodiment of a memory device of FIG. 1. The storage device 1000 of FIG. 1 may be a flash storage device based on a flash memory. For example, the storage device 1000 may be implemented as a solid-state drive (SSD), a universal flash storage (UFS), a memory card, etc.

Referring to FIGS. 1 and 16, the memory device 1100 may include a memory cell array 1110 and a core/peripheral circuit 1115. The core/peripheral circuit 1115 may include an address decoder 1120, a page buffer circuit 1130, an input/output circuit 1140, a wordline voltage generator 1150 and a control logic 1160. In addition, the core/peripheral circuit 1115 may include a sub-wordline driver circuit 1190 and a wordline isolation circuit 100.

The memory cell array 1110 may include a plurality of memory blocks BLK1 to BLKn. Each memory block may include a plurality of pages. Each page may include a plurality of memory cells. Each memory cell may store multi-bit data. Each memory block may be an erase unit, and each page may be a read or write unit.

The memory cell array 1110 may be formed in a direction perpendicular to a substrate. A gate electrode layer and an insulation layer may be alternately deposited on the substrate. Each memory block (for example, BLK1) may be connected to one or more string selection lines SSL, a plurality of wordlines WL1 to WLm, and one or more ground selection lines GSL. WLk is a selected wordline and the remaining word lines WL1 to WLk-1 and WLk+1 to WLm are unselected wordlines.

The address decoder 1120 may be connected to the memory cell array 1110 through selection lines SSL and GSL and word lines WL1 to WLm. The address decoder 1120 may select a wordline during a program or read operation. The address decoder 1120 may receive a wordline voltage VWL from the wordline voltage generator 1150 and provide a program or read voltage to the selected wordline.

The page buffer circuit 1130 may be connected to the memory cell array 1110 through bitlines BL1 to BLz. The page buffer circuit 1130 may temporarily store data to be stored in the memory cell array 1110 or data read from the memory cell array 1110. The page buffer circuit 1130 may include page buffers PB1 to PBz connected to respective bitlines. Each page buffer may include a plurality of latches to store or read multi-bit data.

The input/output circuit 1140 may be internally connected to the page buffer circuit 1130 through data lines and externally connected to the memory controller (e.g., 1200 in FIG. 1) through the input/output lines IO1 to IOn. The input/output circuit 1140 may receive program data from the memory controller 1200 during a program operation. Also, the input/output circuit 1140 may provide data read from the memory cell array 1110 to the memory controller 1200 during a read operation.

The wordline voltage generator 1150 may receive internal power from the control logic 1160 and generate a wordline voltage VWL required to read or write data. The wordline voltage VWL may be provided to selected wordlines sWL or unselected wordlines uWL through the address decoder 1120.

The wordline voltage generator 1150 may include a program voltage generator and a pass voltage generator. The program voltage generator may generate a program voltage provided to selected wordlines sWL during a program operation. The pass voltage generator may generate a pass voltage provided to selected wordlines sWL and unselected wordlines uWL.

The wordline voltage generator 1150 may include a read voltage generator and a read pass voltage generator. The read voltage generator may generate a selected read voltage provided to selected wordlines sWL during a read operation. The read pass voltage generator may generate a read pass voltage provided to unselected wordlines uWL. The read pass voltage may be a voltage sufficient to turn on memory cells connected to unselected wordlines uWL during the read operation.

The control logic 1160 may control operations such as read, write and erase of the memory device 1100 using commands CMD, addresses ADDR and/or control signals CTRL provided from the memory controller 1200. The addresses ADDR may include a block selection address for selecting one memory block, a row address for selecting one page and/or a column address for selecting one memory cell.

The sub-wordline driver circuit 1190 may receive wordline driving signals from the address decoder 1120. When the sub-wordline driver circuit 1190 is connected to wordlines, the same test voltage may be applied to the core/peripheral circuit 1115 and memory cell array 1110 during the burn-in test. To save test time and ensure reliability of the core/peripheral circuit 1115, a test voltage higher than the operating voltage of the memory device 1100 may be applied during the burn-in test. However, memory cells included in the memory cell array 1110 may require lower reliability than the core/peripheral circuit 1115. Accordingly, during the burn-in test, an excess number of defective memory cells may be detected as defective unnecessarily among the memory cells included in the memory cell array 1110.

The core/peripheral circuit 1115 may include a wordline isolation circuit 100. As described in FIGS. 3-14, the wordline isolation circuit 100 may connect or isolate wordlines to or from the sub-wordline driver circuit 1190. For example, during the burn-in test, the wordline isolation circuit 100 may isolate wordlines from the sub-wordline driver circuit 1190. During a normal operation (e.g., after a product shipment), the wordline isolation circuit 100 may connect wordlines to the sub-wordline driver circuit 1190. Accordingly, during the burn-in test, memory cells which may be unnecessarily treated as defective among the memory cells of the memory device 1100 may be reduced. Additionally, during the burn-in test, various and/or sophisticated test environments may be set for the core/peripheral circuit 1115 or the memory cell array 1110.

According to the present disclosure, it may be possible to perform the burn-in test on a core/peripheral circuit and a memory cell array with different test voltages.

According to the present disclosure, it may be possible to reduce memory cells which may be unnecessarily treated as defective during the burn-in test.

According to the present disclosure, it may be possible to efficiently perform the burn-in test according to characteristics of a core/peripheral circuit and a memory cell array.

While the present disclosure has been described with reference to example embodiments thereof, it will be apparent to those of ordinary skill in the art that various changes and modifications may be made thereto without departing from the spirit and scope of the present disclosure as set forth in the following claims and their equivalents.

What is claimed is:

1. A burn-in test method for a memory device comprising a memory cell array, a wordline isolation circuit, and a sub-wordline driver circuit, the burn-in test method comprising:
performing a first burn-in test by controlling the wordline isolation circuit to a turn-off state and outputting a first test voltage from the sub-wordline driver circuit; and
performing a second burn-in test by changing the wordline isolation circuit to a turn-on state and outputting a second test voltage lower than the first test voltage from the sub-wordline driver circuit.

2. The burn-in test method of claim 1, further comprising, after the performing the second burn-in test:
performing a normal operation mode by maintaining the wordline isolation circuit in the turn-on state.

3. The burn-in test method of claim 1, further comprising, after the performing the first burn-in test:
controlling the wordline isolation circuit to a standby mode by changing the wordline isolation circuit to the turn-on state and outputting a ground voltage from the sub-wordline driver circuit.

4. The burn-in test method of claim 1, wherein the second test voltage is higher than or equal to an operating voltage of the memory device.

5. The burn-in test method of claim 1, wherein the outputting the first test voltage comprises outputting the first test voltage of which a level is based on a reliability of a core/peripheral circuit comprising the sub-wordline driver circuit.

6. The burn-in test method of claim 1, wherein the outputting the second test voltage comprises outputting the second test voltage of which a level is based on a reliability of memory cells included in the memory device.

7. The burn-in test method of claim 1, wherein the wordline isolation circuit is between the sub-wordline driver circuit and wordlines connected to the memory cell array.

8. The burn-in test method of claim 1, wherein the performing the second burn-in test comprises controlling the wordline isolation circuit to the turn-on state based on an isolation signal applied thereto, to transmit the second test voltage.

9. A memory device comprising:
a memory cell array comprising a plurality of memory cells;
a plurality of wordlines connected to the plurality of memory cells;
a row decoder configured to transmit a wordline driving signal to a selected wordline among the plurality of wordlines;
a sub-wordline driver circuit configured to transmit the wordline driving signal to the selected wordline; and
a wordline isolation circuit configured to selectively connect or disconnect the plurality of wordlines to or from the sub-wordline driver circuit based on an isolation signal in a burn-in test.

10. The memory device of claim 9, wherein the wordline isolation circuit is configured to be turned on or turned off in a standby mode of the burn-in test.

11. The memory device of claim 9, wherein, in a first test mode of the burn-in test, the sub-wordline driver circuit is configured to output a first test voltage and the wordline isolation circuit is turned off to disconnect the plurality of wordlines from the sub-wordline driver circuit.

12. The memory device of claim 11, wherein the first test voltage is higher than a normal operating voltage of the sub-wordline driver circuit.

13. The memory device of claim 11, wherein a level of the first test voltage is based on a reliability of a core/peripheral circuit comprising the sub-wordline driver circuit.

14. The memory device of claim 11, wherein, in a second test mode of the burn-in test, the sub-wordline driver circuit is configured to output a second test voltage lower than the first test voltage and the wordline isolation circuit is turned on to connect the plurality of wordlines to the sub-wordline driver circuit.

15. The memory device of claim 14, wherein the second test voltage is higher than a normal operating voltage of the sub-wordline driver circuit.

16. The memory device of claim 14, wherein a level of the second test voltage is based on a reliability of the plurality of memory cells.

17. The memory device of claim 9, wherein the wordline isolation circuit is configured to maintain in a turn-on state in a normal operation mode.

18. A burn-in test method for a memory device comprising a memory cell array, a plurality of wordlines connected to a plurality of memory cells included in the memory cell array, a sub-wordline driver circuit configured to transmit wordline driving signals to the plurality of wordlines, and a wordline isolation circuit configured to selectively connect or disconnect the plurality of wordlines and the sub-wordline driver circuit based on an isolation signal, the burn-in test method comprising:
disconnecting the plurality of wordlines from the sub-wordline driver circuit by the wordline isolation circuit, and outputting a first test voltage by the sub-wordline driver circuit, based on the memory device being in a process of manufacturing a wafer;
disconnecting the plurality of wordlines from the sub-wordline driver circuit by the wordline isolation circuit, and outputting a second test voltage lower than the first test voltage by the sub-wordline driver circuit, based on the memory device being in a process of manufacturing a package; and
connecting the plurality of wordlines to the sub-wordline driver circuit by the wordline isolation circuit, and outputting a third test voltage lower than the second test voltage by the sub-wordline driver circuit, based on the memory device being in a module manufacturing process.

19. The burn-in test method of claim 18, wherein levels of the first test voltage and the second test voltage are based on a reliability of a core/peripheral circuit comprising the sub-wordline driver circuit.

20. The burn-in test method of claim 18, wherein the third test voltage is equal to a normal operating voltage of the sub-wordline driver circuit.
